(19) United States
(12) Patent Application Publication
(10) Pub. No.: US 2017/0142178 A1
(43) Pub. Date: May 18, 2017

(54) SERVER DEVICE, INFORMATION PROCESSING METHOD FOR SERVER DEVICE, AND PROGRAM

(71) Applicant: SONY SEMICONDUCTOR SOLUTIONS CORPORATION, Kanagawa (JP)

(72) Inventors: RYUJI TOKUNAGA, TOKYO (JP); HIROYUKI FUKUCHI, KANAGAWA (JP)

(21) Appl. No.: 15/323,005

(22) PCT Filed: Jul. 6, 2015
(86) PCT No.: PCT/JP2015/069380

§ 371 Date: Dec. 29, 2016

(30) Foreign Application Priority Data
Jul. 18, 2014 (JP) 2014-147596

(51) Int. Cl. H04L 29/06; G10L 19/16; G06F 3/16; H04L 29/08

(52) U.S. Cl. CPC H04L 65/601; H04L 67/10; G10L 19/167; G06F 3/165; G10L 19/173; H04N 21/2335

(57) ABSTRACT

The present technology relates to a server device, an information processing method for the server device, and a program, which optimize, in accordance with an audio output function of a reproduction device, the content to be distributed without adding any specific configuration to the reproduction device and allow the reproduction of the content. A television receiver serving as a reproduction device is caused to output measurement audio therefrom. A mobile terminal collects the audio output from the reproduction device and then transmits the audio to the server device. The server device stores adjustment information according to the performance and functions of an audio output of each reproduction device on the basis of the audio. When the content is reproduced, the server device adjusts content data on the basis of the adjustment information and distributes the content data to the reproduction device. The present technology is applicable to a content distribution system.

### CROSS REFERENCE TO RELATED APPLICATIONS

This application is a U.S. National Phase of International Patent Application No. PCT/JP2015/069380 filed on Jul. 6, 2015, which claims priority benefit of Japanese Patent Application No. JP 2014-147596 filed in the Japan Patent Office on Jul. 18, 2014. Each of the above-referenced applications is hereby incorporated herein by reference in its entirety.

### TECHNICAL FIELD

The present technology relates to a server device, an information processing method for the server device, and a program. Particularly, the present technology relates to a server device, an information processing method for the server device, and a program, which adjust content to be distributed from the server to an optimal state for the performance of a reproduction device and enable the reproduction device to reproduce the content, without adding any special configuration to the reproduction device upon reproducing the content.

### BACKGROUND ART

There has been a widespread service that for example, allows content being streamed from a server to be viewed using a mobile terminal, represented by a smart phone, a television receiver, or the like (for example, see Patent Document 1).

Accordingly, for example, there may be a situation where content viewed on a mobile terminal is liked, thus leading to a desire to view the content on a high quality reproduction device, such as a television receiver or an audio system installed in a residence or the like. In such a case, a user views the content that has been viewed on the mobile terminal using a high quality reproduction device such as a television receiver or an audio system.

In such a case, the user expects that by viewing on the high-quality reproduction device such as a television receiver or an audio system, the user can view with a high quality image and audio in a more powerful manner.

### CITATION LIST

### Patent Document

Patent Document 1: Re-publication of PCT International Publication (WO 2003/098960, Japanese Patent Application No. 2004-506308)

### SUMMARY OF THE INVENTION

### Problems to be Solved by the Invention

However, depending on a combination of a state of content data and the performance of a reproduction device, it has not always been the case that a high quality image or audio can be output.

Therefore, conventionally, the reproduction device has been provided with a digital signal processor (DSP) for performing image improving processing and audio quality improving processing. With the DSP improving the image quality and the audio quality, distributed content has been output as a high quality image and audio.

However, such a case has sometimes resulted in an increase in the cost of the reproduction device itself, due to the DSP, which is expensive, provided therefor.

The present technology improves content to suitable audio and images for the performance of a reproduction device and allows the improved content to be viewed, without adding any special configuration to the reproduction device.

### Solutions to Problems

A server device according to one aspect of the present technology distributes content to a reproduction device and includes an adjustment unit configured to adjust content data of the content to correspond to a reproduction function of the reproduction device.

An analysis unit and an adjustment information storage unit may be included. The analysis unit may analyze audio output from the reproduction device. The adjustment information storage unit may store, in association with information identifying the reproduction device, adjustment information necessary for adjusting the content data to correspond to the reproduction function of each reproduction device based on an analysis result of the analysis unit. The adjustment unit may adjust the content data on the basis of the adjustment information.

The analysis unit may analyze a frequency characteristic and a phase characteristic of the audio output from the reproduction device. The adjustment information storage unit may store the adjustment information necessary for adjusting the content data to correspond to the frequency characteristic and the phase characteristic of the reproduction function of the reproduction device on the basis of the analysis result of the analysis unit. The adjustment unit may adjust the content data to correspond to the frequency characteristic and the phase characteristic of the reproduction function of the reproduction device on the basis of the adjustment information.

The analysis unit may analyze availability of virtualizer of the reproduction device on the basis of the audio output from the reproduction device. The adjustment information storage unit may store, as the adjustment information, information indicating necessity of adjusting the content data with the virtualizer, when the virtualizer is not included in the reproduction function of the reproduction device, on the basis of the analysis result of the analysis unit. The adjustment unit may adjust the content data by performing virtualizer processing to correspond to the reproduction function of the reproduction device on the basis of the adjustment information.

The analysis unit may analyze a coding format of the reproduction device on the basis of the audio output from the reproduction device. The adjustment information storage unit may store, as the adjustment information, information indicating the coding format corresponding to the reproduction function of the reproduction device based on the analysis result of the analysis unit. The adjustment unit may process and adjust the content data such that the coding format corresponds to the reproduction function of the reproduction device on the basis of the adjustment information.

The analysis unit may analyze the number of channels of the reproduction device on the basis of the audio output from the reproduction device. The adjustment information storage unit may store, as the adjustment information, information indicating the number of channels corresponding to the reproduction function of the reproduction device based on the analysis result of the analysis unit. The adjustment unit may process and adjust the content data such that the number of channels corresponds to the reproduction function of the reproduction device based on the adjustment information.

The analysis unit may analyze a sampling frequency of the reproduction device on the basis of the audio output from the reproduction device. The adjustment information storage unit may store, as the adjustment information, information indicating the sampling frequency corresponding to the reproduction function of the reproduction device on the basis of the analysis result of the analysis unit. The adjustment unit may adjust the content data by converting a sampling rate such that the sampling frequency corresponds to the reproduction function of the reproduction device based on the adjustment information.

The reproduction device includes an audio quality adjustment unit configured to adjust audio quality of the content to be reproduced. The server device may further include a command output unit configured to output a command for stopping an operation of the audio quality adjustment unit. The analysis unit may analyze both of audios output from the reproduction device during the audio quality adjustment unit being in an operating state and being in an inoperative state by the command output unit. The adjustment information storage unit may store, for each of the operating state and the inoperative state of the audio quality adjustment unit, the adjustment information being associated with the information identifying the reproduction device and necessary for adjusting the content data to correspond to the reproduction function of each reproduction device based on the analysis result of the analysis unit. The adjustment unit may make an adjustment to correspond to the reproduction function of the reproduction device based on the adjustment information for each of the operating state and the inoperative state of the audio quality adjustment unit.

The content may include content to be distributed through a broadcast wave. A delay processing unit, configured to reassign, in a case where the content is distributed via the broadcast wave, a timestamp according to a delay generated when the content data is adjusted by the adjustment unit, is further included.

The server device may configure a distribution system together with a mobile terminal and the reproduction device, the mobile terminal configured to collect audio output from the reproduction device. The analysis unit may analyze the audio output from the reproduction device and collected by the mobile terminal.

The server device may include a cloud server device including a plurality of server devices connected via a network.

An information processing method for a server device according to one aspect of the present technology is the information processing method for a server device that distributes content to a reproduction device, and includes the step of adjusting content data of the content to correspond to a reproduction function of the reproduction device.

A program according to one aspect of the present technology is a computer configured to control a server device that distributes content to a reproduction device, and is executed to function as an adjustment unit configured to adjust content data of the content to correspond to a reproduction function of the reproduction device.

According to one aspect of the present technology, content data of content is adjusted to correspond to a reproduction function of a reproduction device when the content is distributed to the reproduction device.

A server device according to one aspect of the present technology may be an independent device or may be a block configured to function as a server device.

### Effects of the Invention

According to one aspect of the present technology, content optimized for the performance of a reproduction device can be distributed without adding any special configuration to the reproduction device.

### BRIEF DESCRIPTION OF DRAWINGS

FIG. 1 is a diagram illustrating an exemplary configuration of an embodiment of a general distribution system.

FIG. 2 is a diagram illustrating an exemplary configuration of an embodiment of a content distribution system to which the present technology is applied.

FIG. 3 is a flowchart describing audio quality/function measurement processing of the distribution system in FIG. 2.

FIG. 4 is a flowchart describing content output processing of the distribution system in FIG. 2.

FIG. 5 is a diagram describing a first modification.

FIG. 6 is a diagram describing a second modification.

FIG. 7 is a diagram describing a third modification.

FIG. 8 is a diagram describing an exemplary configuration of a general-purpose personal computer.

### MODE FOR CARRYING OUT THE INVENTION

<Exemplary Configuration of General Distribution System>

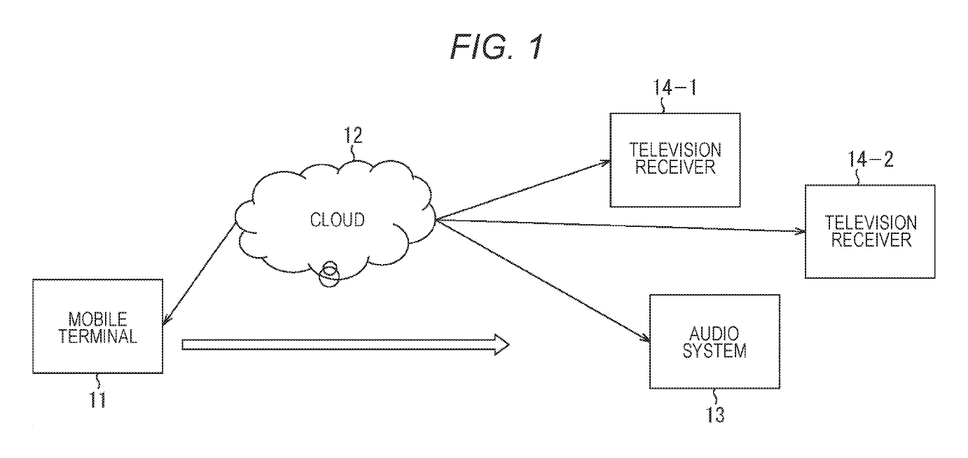

FIG. 1 illustrates an exemplary configuration of a general content distribution system.

The distribution system in FIG. 1 includes a mobile terminal 11, a cloud server device 12, an audio system 13, and television receivers 14-1 and 14-2. Note that the television receivers 14-1 and 14-2 will be simply referred to as a television receiver 14 when there is no specific need to make a distinction therebetween, and will also be referred to similarly in other configurations.

The cloud server device 12 is organically configured with a plurality of servers (computers) via a network, and functions as if the cloud server device 12 were a single server. The cloud server device 12 distributes content in response to a request from the mobile terminal 11, the audio system 13, and the television receivers 14-1 and 14-2.

The mobile terminal 11 is, for example, what is called, a smart phone. The mobile terminal 11 requests the cloud server device 12 to distribute the content and receives the content distributed in response to the request. The mobile terminal 11 then reproduces the content as an image and audio.

The audio system 13 requests the cloud server device 12 to distribute the content via the network. The audio system 13 then receives the content distributed from the cloud server device 12 and reproduces audio.

The television receivers 14-1 and 14-2 request the cloud server device 12 to distribute the content via the network. The television receivers 14-1 and 14-2 receive the content distributed from the cloud server device 12 and reproduce the content as an image and audio.

The conventional configuration has been such that, for example, to allow a user having viewed content on the mobile terminal 11 to enjoy the content, which the user has liked while viewing, with a powerful image and audio, the audio system 13 or the television receiver 14 requests the content from the cloud server device 12, and the content distributed in response to the request is viewed.

However, in this case, even when the image and audio of the content distributed from the cloud server device 12 are output by the audio system 13 or the television receiver 14, the image and audio data of the content are not always optimized for the hard ware (HW) performance of the audio system 13 or the television receiver 14, and the performance thereof is not exhibited sufficiently. This leads to a risk that the output image and audio may not be of high quality.

Accordingly, it is considered that performing optimization on an individual device basis by providing a digital signal processor (DSP) for the audio system 13 or the television receiver 14 will produce a more powerful image and audio.

However, in this case, there has been a risk of an increase in cost due to the installation of the DSP.

<Exemplary Configuration of Distribution System of Present Technology>

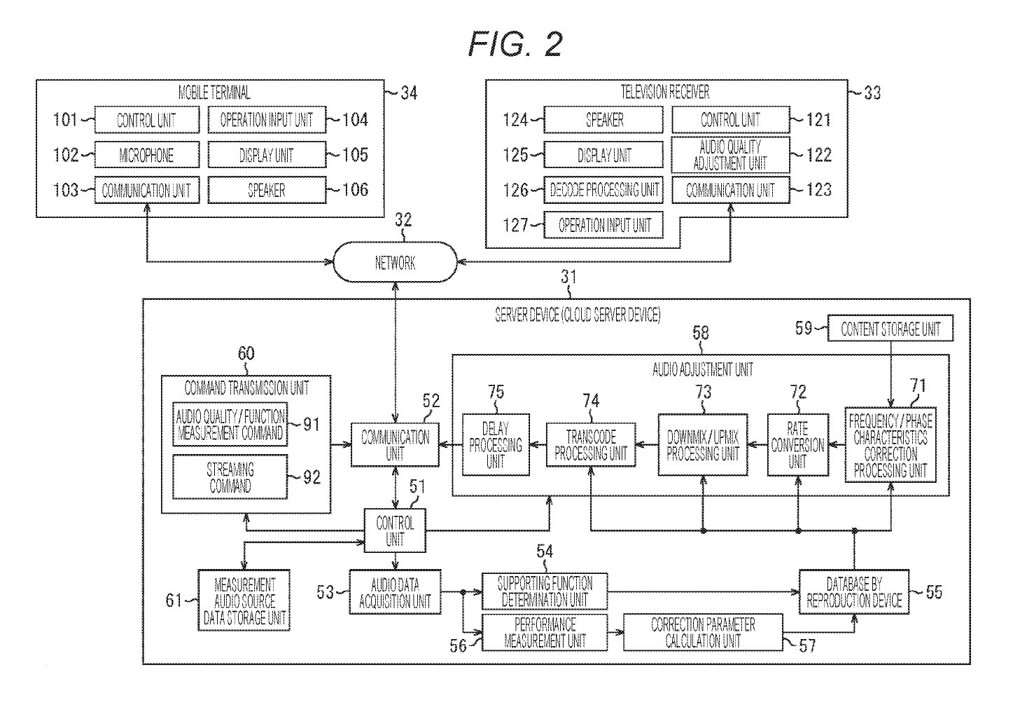

Next, a content distribution system of one aspect of the present technology will be described with reference to FIG. 2.

The distribution system in FIG. 2 includes a server device 31, a network 32, a television receiver 33, and a mobile terminal 34. Additionally, an audio system that reproduces only audio of the content may also be included.

The server device 31 may also be configured with a cloud system in conjunction with the network 32. Therefore, although the server device 31 is configured with a single server device 31 in FIG. 2, the server device 31 may also be realized with a cloud server device including a plurality of computers and the like including the network 32.

More specifically, the server device 31 includes a control unit 51, a communication unit 52, an audio data acquisition unit 53, a supporting function determination unit 54, a database by reproduction device 55, a performance measurement unit 56, a correction parameter calculation unit 57, an audio adjustment unit 58, a content storage unit 59, a command transmission unit 60, and a measurement audio source data storage unit 61.

The control unit 51 includes a microcomputer and the like including a central processing unit (CPU), a random access memory (RAM), and a read only memory (ROM), and controls the whole operations of the server device 31.

The communication unit 52 includes an Ethernet (registered trademark) board and the like, and transmits and receives various data to and from the television receiver 33, the mobile terminal 34, and the like, via the network 32.

The audio data acquisition unit 53 acquires audio data transmitted by the mobile terminal 34 via the communication unit 52. The audio data includes audio generated by the television receiver 33 and collected by the mobile terminal 34. The audio data acquisition unit 53 outputs the audio data to the supporting function determination unit 54 and the performance measurement unit 56.

The supporting function determination unit 54 analyzes the audio data, and determines supported functions of the television receiver 33 serving as a reproduction device, such as a codec, a sampling frequency, the number of channels, and availability of virtualization. The supported functions are associated with information identifying the television receiver 33 serving as a reproduction device, and registered in the database by reproduction device 55.

The performance measurement unit 56 analyzes the audio data, and determines the frequency characteristic and the phase characteristic. The performance measurement unit 56 then supplies the determination result to the correction parameter calculation unit 57.

The correction parameter calculation unit 57 calculates, on the basis of the frequency characteristic and the phase characteristic, a correction parameter for each. The correction parameter calculation unit 57 associates the calculated correction parameters with the information identifying the television receiver 33 serving as a reproduction device, and registers the correction parameters as adjustment information in the database by reproduction device 55.

In association with the information identifying the television receiver 33 serving as a reproduction device, the database by reproduction device 55 stores the codec, the sampling frequency, the number of channels, and the availability of the virtualization as the supported function information, while also storing the correction parameters calculated on the basis of the frequency characteristic and the phase characteristic as the adjustment information. Furthermore, the database by reproduction device 55 supplies, to the audio adjustment unit 58, the stored supported function information and adjustment information including the correction parameter information which have been associated with the information identifying the reproduction device.

The audio adjustment unit 58 reads, from the content storage unit 59, the content requested by the television receiver 33 or the mobile terminal 34 serving as a reproduction device, and adjusts the audio data of the content on the basis of the information stored in the database by reproduction device 55. The audio adjustment unit 58 controls the communication unit 52 to distribute the content to the television receiver 33 or the mobile terminal 34 serving as a reproduction device.

More specifically, the audio adjustment unit 58 includes a frequency/phase characteristics correction processing unit 71, a rate conversion unit 72, a downmix/upmix processing unit 73, a transcode processing unit 74, and a delay processing unit 75.

The frequency/phase characteristics correction processing unit 71 reads, from the content storage unit 59, the data of the content requested for reproduction. For the audio data of the content data, the frequency/phase characteristics correction processing unit 71 corrects the frequency characteristics and the phase characteristic on the basis of the correction parameters stored as the adjustment information in the database by reproduction device 55. The frequency/phase characteristics correction processing unit 71 supplies, to the rate conversion unit 72, the content including the audio data in which the frequency characteristics and the phase characteristic have been corrected using the correction parameters. This is, in a case where an audio system is configured with a plurality of speaker units, the frequency characteristic of each speaker varies. Furthermore, since it is not always the case that each speaker's driving surface is aligned to the position of a listener, the phase characteristic of each speaker also varies. In view of the foregoing, adjusting the frequency characteristic and the phase characteristic is necessary, in order to constitute appropriate sound image localization according to the position of the listener. Therefore, the frequency/phase characteristics correction processing unit 71 corrects the frequency characteristic and the phase characteristic of each speaker using the correction parameters, and constitutes optimal sound image localization for the position where the listener is located.

For the audio data of the content readout by the content storage unit 59 based on reproduction request, the rate conversion unit 72 converts a sampling rate of the audio data of the content data on the basis of the information on a sampling frequency included in the adjustment information stored in the database by reproduction device 55. The rate conversion unit 72 then outputs the audio data of the content to the downmix/upmix processing unit 73.

For the audio data of the content data readout by the content storage unit 59 based on reproduction request, the downmix/upmix processing unit 73 performs processing of, for example, adding the number of channels and virtualizer of the audio data of the content data, on the basis of the information on the number of channels and availability of the virtualizer included in the adjustment information stored in the database by reproduction device 55. The downmix/upmix processing unit 73 then outputs the audio data of the content to the transcode processing unit 74. Note that the virtualizer described herein is processing to the audio data or the function thereof that allows a listener to listen as if a channel that physically does not exist existed virtually. More specifically, for example, a two-channel audio system is configured in which only a total of two speakers exists to the front right and left of the listener. The virtualizer is processing or the function thereof that allows the listener to listen as if, in this case, the audio system were a four-channel audio system with two surround speakers provided to the listener's right and left back side and the audio also being generated therefrom.

The transcode processing unit 74 transcodes the audio data of the content data readout by the content storage unit 59 based on reproduction request into a predetermined compression format, on the basis of the codec information included in the adjustment information stored in the database by reproduction device 55. The transcode processing unit 74 then outputs the audio data of the content to the delay processing unit 75.

The delay processing unit 75 reassigns a timestamp to adjust a delay generated to the image due to the time taken for processing the audio data of the content to be distributed to the television receiver 33. An output is made to the communication unit 52.

The command transmission unit 60 is controlled by the control unit 51, and transmits, to the television receiver 33 via the communication unit 52, a command for measuring the audio quality and functions and a command for starting streaming. More specifically, the command transmission unit 60 stores an audio quality/function measurement command 91 and a streaming command 92 to the television receiver 33. The audio quality/function measurement command 91 is for measuring audio quality and functions. The streaming command 92 is for starting streaming. The command transmission unit 60 outputs, where appropriate and at necessary timing, the audio quality/function measurement command 91 and the streaming command 92 to the communication unit 52, so that the audio quality/function measurement command 91 and the streaming command 92 are transmitted to the television receiver 33.

The measurement audio source data storage unit 61 stores measurement audio source data. The measurement audio source data is for causing the audio to be generated from the television receiver 33 when measuring the audio quality and functions. In measuring the audio quality and functions, the measurement audio source data is read by the control unit 51 and transmitted to the television receiver 33 via the communication unit 52.

The television receiver 33 includes a control unit 121, an audio quality adjustment unit 122, a communication unit 123, a speaker 124, a display unit 125, a decode processing unit 126, and an operation input unit 127.

The control unit 121 controls the entire operations of the television receiver 33.

According to the operation detail of the operation input unit 127 including an operation button and the like, the audio quality adjustment unit 122 adjusts the audio quality of the audio data of the content transmitted from the server device 31 through the communication unit 123 via the network 32. The audio quality adjustment unit 122 then outputs the audio data from the speaker 124.

The communication unit 123 includes an Ethernet (registered trademark) board and the like. The communication unit 123 transmits and receives various data to and from the server device 31 via the network 32 while being controlled by the control unit 121.

The display unit 125 includes a liquid crystal display (LCD) and the like. The display unit 125 displays an image of the content data received from the server device 31 through the communication unit 123 via the network 32.

The decode processing unit 126 decodes the content data received from the server device 31 through the communication unit 123 via the network 32. The decode processing unit 126 outputs image data and audio data as decoding results to the control unit 121.

The mobile terminal 34 is, what is called, a smart phone or a mobile phone, including a control unit 101, a microphone 102, and a communication unit 103.

The control unit 101 controls the entire operations of the mobile terminal 34. The microphone 102 collects audio and supplies the audio to the control unit 101 while being controlled by the control unit 101. In addition, the control unit 101 communicates with another mobile terminal 34 through the network 32 or a public network that is not shown, while controlling the communication unit 103. The control unit 101, for example, causes the speaker 106 to output the audio data being supplied.

The communication unit 103 includes an Ethernet (registered trademark) board and the like. The communication unit 103 transmits and receives various data to and from the server device 31, the television receiver 33, and the like via the network 32, while being controlled by the control unit 101.

The operation input unit 104, including an operation button and the like, is a touch panel or the like in which a display unit 105 is integrated, for example. The display unit 105 includes a liquid crystal display (LCD) and the like. The operation input unit 104 supplies, to the control unit 101, a signal according to the detail of the operation.

<Audio Quality/Function Measurement Processing>

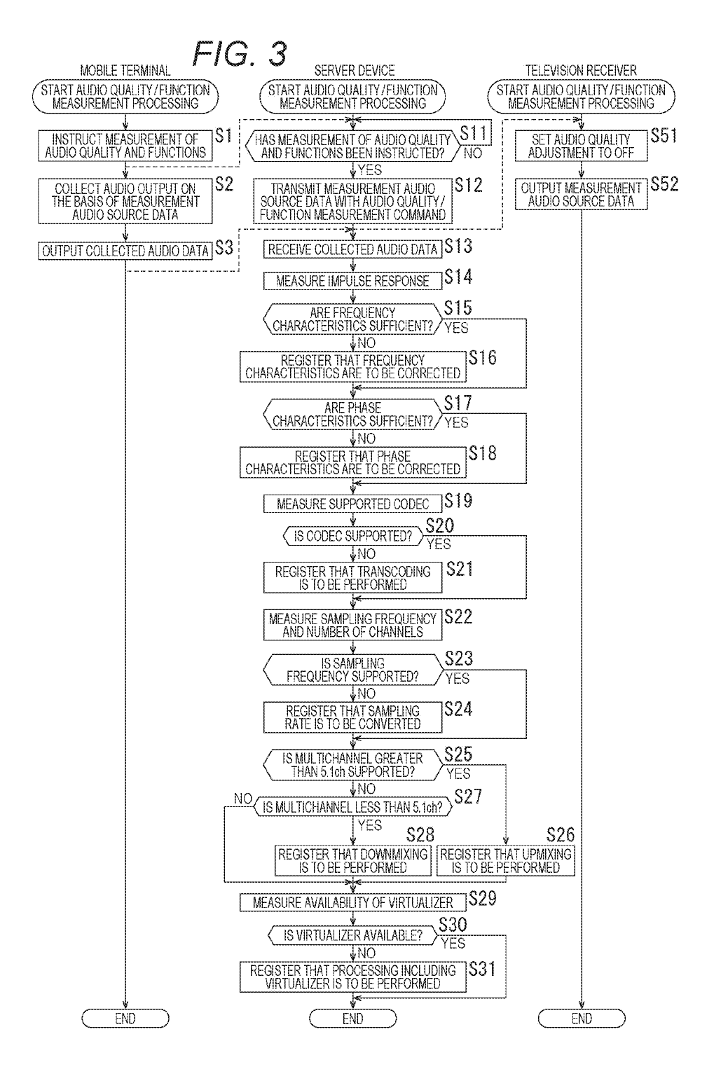

Next, the audio quality/function measurement processing in the distribution system in FIG. 2 will be described with reference to the flowchart in FIG. 3. More specifically, the mobile terminal 34 requests the server device 31 to cause audio for measuring the audio quality and functions of the television receiver 33 to be output. Then, the mobile terminal 34 collects the measurement audio generated by the television receiver 33, and transmits the audio collection result to the server device 31. Then, the server device 31 stores, in association with identification information of the television receiver 33, adjustment information in the database by reproduction device 55. The adjustment information serves as a measurement result of the audio quality and functions. In this manner, by using the adjustment information, the audio data of the content to be distributed to the television receiver 33 can be distributed by the server device 31 as optimal audio data for the functions and performance of the television receiver 33.

More specifically, in step S1, when the user operates the operation input unit 104 of the mobile terminal 34 and inputs information specifying the television receiver 33 (to be served as) a reproduction apparatus by which the user reproduces the content; and at the same time, when an instruction is given to measure and register the audio quality and functions of the television receiver 33, the control unit 101 controls the communication unit 103 to transmit information instructing the server device 31 to measure the audio quality and functions.

In step S11, the control unit 51 of the server device 31 controls the communication unit 52 and determines whether the measurement of the audio quality and functions has been instructed. Similar processing is repeated until the instruction is transmitted. In step S11, for example, when the measurement of the audio quality and functions is instructed by the processing in step S1, the processing proceeds to step S12.

In step S12, the control unit 51 reads the measurement audio source data from the measurement audio source data storage unit 61. The control unit 51 controls the command transmission unit 60 to transmit the measurement audio source data as well as the audio quality/function measurement command 91 to the television receiver 33 to be served as a reproduction device via the communication unit 52.

When the control unit 121 receives the audio quality/function measurement command 91 and the measurement audio source data by controlling the communication unit 123 in step S51, the control unit 121 turns off the audio quality adjustment unit 122 to stop the operation thereof. In other words, with this processing, the audio which is based on the measurement audio source data and to be output from the speaker 124 of the television receiver 33 is not adjusted by the audio quality adjustment unit 122. In this manner, the performance of the speaker 124 can be measured accurately.

In step S52, the control unit 121 controls the decode processing unit 126 to decode the measurement audio source data, and then causes the speaker 124 to output the measurement audio source data as audio. More specifically, here, the audio decoded on the basis of the measurement audio source data is output as the audio from which the characteristic and the other functions of the speaker 124 are easily recognized. In addition, when a plurality of audios needed for recognizing a plurality of functions exists for each function, the measurement audio source data includes a plurality of audio data. The audios for recognizing the plurality of functions are sequentially switched and output from the speaker 124 at a predetermined time interval.

In response, in step S2, the control unit 101 of the mobile terminal 34 controls the microphone 102 to collect the audio. Here, it is assumed that the mobile terminal 34 is operated adjacent to the television receiver 33. Therefore, the microphone 102 collects the audio of the measurement audio source output from the speaker 124 on the basis of the measurement audio source data decoded in the television receiver 33.

In step S3, the control unit 101 compresses the audio data, which is based on the measurement audio source and collected by the microphone 102, into a predetermined format. The control unit 101 then controls the communication unit 103 to transmit the audio data to the server device 31.

In step S13, the control unit 51 receives, by controlling the communication unit 52, the collected audio data which has been compressed into the predetermined format and transmitted by the mobile terminal 34. The control unit 101 then expands and supplies the audio data to the audio data acquisition unit 53.

In step S14, the audio data acquisition unit 53 outputs the supplied audio data as an audio collection result to the supporting function determination unit 54 and the performance measurement unit 56. The performance measurement unit 56 measures an impulse response on the basis of the audio data.

In step S15, the performance measurement unit 56 determines whether the frequency characteristic is sufficient on the basis of the measurement result of the impulse response. When the frequency characteristic is determined to be insufficient, the processing proceeds to step S16.

In step S16, the performance measurement unit 56 supplies the audio data and the measurement result of the impulse response to the correction parameter calculation unit 57. On the basis of the audio data and the measurement result of the impulse response, the correction parameter calculation unit 57 calculates a correction parameter necessary for the correction of the frequency characteristic. Then, the correction parameter calculation unit 57 registers, in association with the information identifying the television receiver 33 to be served as a reproduction device, information indicating the necessity of correcting the frequency characteristic and the correction parameter necessary for the correction as the adjustment information of the audio data of the content in the database by reproduction device 55. More specifically, when the correction of the frequency characteristic is determined to be necessary, the correction parameter calculation unit 57 calculates the correction parameter, by which a digital filter may be constituted, for example. The digital filter generates an inverse impulse response based on the impulse response.

Note that when the frequency characteristic is determined to be sufficient in step S15, the processing in step S16 is skipped. More specifically, in this case, by not registering the information that the correction of the frequency characteristic is necessary, the database by reproduction device 55 substantially registers that the correction of the frequency characteristic is not necessary.

In step S17, the performance measurement unit 56 determines whether the phase characteristic is sufficient on the basis of the measurement result. When the phase characteristic is determined to be insufficient, the processing proceeds to step S18.

In step S18, the performance measurement unit 56 supplies the audio data and the measurement result to the correction parameter calculation unit 57. On the basis of the audio data and the measurement result, the correction parameter calculation unit 57 calculates a correction parameter necessary for the correction of the phase characteristic. Then, the correction parameter calculation unit 57 registers, in association with the information identifying the television receiver 33 to be served as a reproduction device, information indicating the necessity of correcting the phase characteristic and the correction parameter necessary for the correction as the adjustment information of the audio data of the content in the database by reproduction device 55. More specifically, the correction parameter calculation unit 57 calculates the phase characteristic using the audio data and the measurement result. The correction parameter calculation unit 57 then calculates the correction parameter with which the phase is corrected in such a way that the phase difference between each channel becomes zero, for example.

Note that when the phase characteristic is determined to be sufficient in step S17, the processing in step S18 is skipped. More specifically, in this case, by not registering the information that the correction of the phase characteristic is necessary, the database by reproduction device 55 substantially registers that the correction of the phase characteristic is not necessary.

In step S19, the supporting function determination unit 54 measures a codec on the basis of the audio data.

In step S20, the supporting function determination unit 54 determines whether the codec employed in the content to be distributed is a codec that the television receiver 33 can support. When the codec cannot be supported, the processing proceeds to step S21.

In step S21, the supporting function determination unit 54 registers, in association with the information identifying the television receiver 33 to be served as a reproduction device, information indicating the necessity of performing transcoding as the adjustment information in the database by reproduction device 55.

Note that when transcoding is determined to be sufficient in step S20, the processing in step S21 is skipped. More specifically, in this case, by not registering the information that transcoding is necessary, the database by reproduction device 55 substantially registers that transcoding is not necessary.

In step S22, the supporting function determination unit 54 measures a sampling frequency and the number of channels on the basis of the audio data.

More specifically, for example, in the processing in step S12, the control unit 51 transmits, to the television receiver 33, the following kinds of audio source data: a 1 channel (ch) audio source, a 2ch audio source, a 5.1ch audio source, and a 7.1ch audio source as audio source data for measuring the number of channels. The audio source data for measuring the number of channels is stored in the measurement audio source data storage unit 61.

More specifically, the 1ch audio source is an audio source that only includes a 100 Hz sine wave. The 2ch audio source is an audio source that only includes sine waves of left (L)=100 Hz and right (R)=200 Hz. In addition, the 5.1ch audio source is an audio source that only includes sine waves of left (L)=100 Hz, right (R)=200 Hz, center (C)=500 Hz, left surround (Ls)=1 kHz, right surround (Rs)=2 kHz, and low-frequency effects (LFE)=50 Hz. Furthermore, the 7.1ch audio source is an audio source that only includes sine waves of left (L)=100 Hz, right (R)=200 Hz, center (C)=500 Hz, left surround (Ls)=1 kHz, right surround (Rs)=2 kHz, left surround rear (Lsr)=3 kHz, right surround rear (Rsr)=4 kHz, and low-frequency effects (LFE)=50 Hz.

Then, in step S52, the control unit 121 of the television receiver 33 controls the decode processing unit 126 to decode the measurement audio source data, and causes the speaker 124 to output the 1ch audio source, the 2ch audio source, the 5.1ch audio source, and the 7.1ch audio source in sequence. At this time, when reaching a channel that cannot be supported, the control unit 121 displays, on the display unit 125, a message indicating that the reproduction is not possible. At the same time, the control unit 121 outputs, from the speaker 124, the audio including a sine wave (e.g., 5 kHz) of other than the 1ch audio source, the 2ch audio source, the 5.1ch audio source, and the 7.1ch audio source. Meanwhile, the control unit 101 of the mobile terminal 34 causes the microphone 102 to collect the audio, and transmits an audio file as an audio collection result to the server device 31. When the supporting function determination unit 54 of the server device 31 analyzes the frequency and a 5 kHz frequency component is found to be included, the supporting function determination unit 54 of the server device 31 determines that the number of channels of the measurement audio source that has been reproduced just before is not supported.

In step S23, the supporting function determination unit 54 determines whether the sampling frequency employed in the content to be distributed is a sampling frequency that the television receiver 33 can support. When the sampling frequency cannot be supported, the processing proceeds to step S24.

In step S24, the supporting function determination unit 54 registers, in association with the information identifying the television receiver 33 to be served as a reproduction device, information indicating the necessity of converting the sampling frequency as the adjustment information in the database by reproduction device 55.

Note that when it is determined in step S23 that the sampling frequency can be supported, the processing in step S24 is skipped. More specifically, in this case, by not registering the information that the conversion of the sampling frequency is necessary, the database by reproduction device 55 substantially registers that the conversion of the sampling frequency is not necessary.

In step S25, the supporting function determination unit 54 determines whether the number of channels that the television receiver 33 can support is greater than 5.1 channels. When the supported number of channels is greater than 5.1 channels and supporting is not possible, the processing proceeds to step S26. In other words, since the audio data of normal content is 5.1 channels, it is determined whether the number of channels is greater than 5.1 channels.

In step S26, the supporting function determination unit 54 registers, in association with the information identifying the television receiver 33 to be served as a reproduction device, information indicating the necessity of performing upmixing to increase the number of channels as the adjustment information in the database by reproduction device 55.

In step S25, when the number of channels that the television receiver 33 can support is not greater than 5.1 channels, the supporting function determination unit 54 determines, in step S27, whether the number of channels that the television receiver 33 can support is fewer than 5.1 channels. When the number of channels is fewer than 5.1 channels and supporting is not possible, the processing proceeds to step S28.

In step S28, the supporting function determination unit 54 registers, in association with the information identifying the television receiver 33 to be served as a reproduction device, information indicating the necessity of performing downmixing to decrease the number of channels as the adjustment information in the database by reproduction device 55.

Note that when it is determined in step S27 that the number of channels is 5.1ch and supporting is possible, the processing in step S28 is skipped. More specifically, in this case, by not registering the information that upmixing or downmixing the number of channels is necessary, the database by reproduction device 55 substantially registers that the number of channels is 5.1 channels and thus the conversion of the number of channels is not necessary.

In step S29, the supporting function determination unit 54 measures whether the virtualizer is available on the basis of the audio data.

More specifically, in step S52, the control unit 121 of the television receiver 33, for example, controls the decode processing unit 126 to decode the measurement audio source data, and causes the speaker 124 to output a wav audio source having a different frequency for each channel, with the reproduction start position being aligned at all the channels by the speaker 124. Then, the control unit 101 of the mobile terminal 34 causes the microphone 102 to collect the audio, and transmits an audio file as an audio collection result to the server device 31. Here, it is considered that since the surround component is delayed due to filter processing of the virtualization processing, the surround component is relatively delayed compared to other front channels. Therefore, the supporting function determination unit 54 of the server device 31 may also determine the availability of the virtualizer, depending on whether the delay has occurred.

In step S30, the supporting function determination unit 54 determines whether the virtualizer is applied. When it is determined that the virtualizer is not applied, the processing proceeds to step S31.

In step S31, the supporting function determination unit 54 registers, in association with the information identifying the television receiver 33 to be served as a reproduction device, information indicating the necessity of applying the virtualizer as the adjustment information in the database by reproduction device 55.

Note that when it is determined in step S30 that the virtualizer is applied, the processing in step S31 is skipped. More specifically, in this case, by not registering the information that applying the virtualizer is necessary, the database by reproduction device 55 substantially registers that applying the virtualizer is not necessary.

With the processing above, the audio quality and functions of the television receiver serving as a content reproduction device are measured, whereby the adjustment information for adjusting the audio data of the content is registered in the database by reproduction device 55, while being associated with the information identifying the reproduction device. The adjustment information includes, for example, whether the frequency characteristic and the phase characteristic are to be corrected; the correction parameters thereof; whether transcoding is to be performed; whether the sampling frequency is to be converted; whether upmixing or downmixing according to the number of channels is to be performed; and whether the virtualizer is available.

As a result, in the content output processing to be described later, the content can be distributed by being adjusted to the optimal audio data for each reproduction device that reproduces the content, on the basis of the adjustment information registered in the database by reproduction device 55 for each reproduction device.

<Content Output Processing>

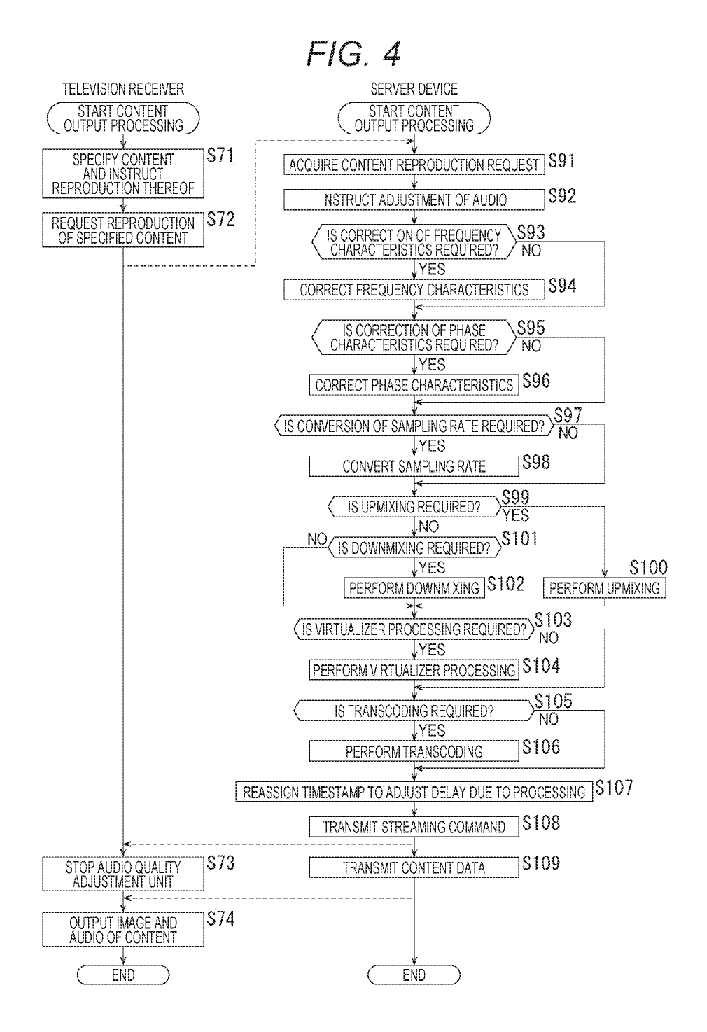

Next, the content output processing in the distribution system in FIG. 2 will be described with reference to the flowchart in FIG. 4.

In step S71, when the operation input unit 127 of the television receiver 33 is operated by a user and an instruction is given to reproduce specified content, the operation input unit 127 outputs, to the control unit 121, an operation signal according to the detail of the operation.

In step S72, the control unit 121 controls the communication unit 123 to transmit, to the server device 31 via the network 32, a request of reproducing the specified content as well as the identification information identifying the television receiver 33 itself.

In step S91, the control unit 51 acquires, by controlling the communication unit 52, the identification information and the information requesting the reproduction of the specified content from the television receiver 33 via the network 32.

In step S92, the audio adjustment unit 58 is instructed to read the specified content as well as the identification information of the television receiver 33 requesting the reproduction of the content, and to add an adjustment to the audio.

In step S93, the frequency/phase characteristics correction processing unit 71 of the audio adjustment unit 58 reads data of the specified content from the content storage unit 59. Then, the frequency/phase characteristics correction processing unit 71 reads adjustment information being associated with the television receiver 33 serving as a reproduction device and registered in the database by reproduction device 55. The television receiver 33 serving as a reproduction device is determined by the identification information. The frequency/phase characteristics correction processing unit 71 then determines whether the correction of the frequency characteristic is necessary.

In step S93, when the correction of the frequency characteristic is, for example, determined to be necessary, the processing proceeds to step S94.

In step S94, for the audio data of the content data, the frequency/phase characteristics correction processing unit 71 corrects the frequency characteristic by using a correction parameter included in the adjustment information, so as to correspond to the television receiver 33 requesting the reproduction of the content.

Note that when the correction of the frequency characteristic is, for example, determined to be unnecessary in step S93, the processing in step S94 is skipped.

In step S95, the frequency/phase characteristics correction processing unit 71 reads the adjustment information being associated with the television receiver 33 serving as a reproduction device and registered in the database by reproduction device 55. The television receiver 33 serving as a reproduction device is determined by the identification information. The frequency/phase characteristics correction processing unit 71 then determines whether the correction of the phase characteristic is necessary.

When the correction of the phase characteristic is, for example, determined to be necessary in step S95, the processing proceeds to step S96.

In step S96, for the audio data of the content data, the frequency/phase characteristics correction processing unit 71 corrects the phase characteristic by using a correction parameter included in the adjustment information, so as to correspond to the television receiver 33 requesting the reproduction of the content. The phase/frequency characteristics correction processing unit 71 then outputs the content data to the rate conversion unit 72.

Note that when the correction of the phase characteristic is, for example, determined to be unnecessary in step S95, the processing in step S96 is skipped, and the content data is output to the rate conversion unit 72.

In step S97, the rate conversion unit 72 reads the adjustment information being associated with the television receiver 33 serving as a reproduction device and registered in the database by reproduction device 55. The television receiver 33 serving as a reproduction device is determined by the identification information. The rate conversion unit 72 then determines whether the conversion of the sampling rate is necessary.

When the conversion of the sampling rate is, for example, determined to be necessary in step S97, the processing proceeds to step S98.

In step S98, for the audio data of the content data, the rate conversion unit 72 converts the sampling rate, so as to correspond to the television receiver 33 requesting the reproduction of the content. The rate conversion unit 72 then supplies the audio data of the content data to the downmix/upmix processing unit 73.

Note that when the correction of the sampling rate is, for example, determined to be unnecessary in step S97, the processing in step S98 is skipped, and the content data is supplied to the downmix/upmix processing unit 73.

In step S99, the downmix/upmix processing unit 73 reads the adjustment information being associated with the television receiver 33 serving as a reproduction device and registered in the database by reproduction device 55. The television receiver 33 serving as a reproduction device is determined by the identification information. The downmix/upmix processing unit 73 then determines whether upmixing is necessary.

When upmixing is, for example, determined to be necessary in step S99, the processing proceeds to step S100.

In step S100, for the audio data of the content data, the downmix/upmix processing unit 73 performs upmixing, so as to correspond to the television receiver 33 requesting the reproduction of the content.

On the other hand, when upmixing is, for example, determined to be unnecessary in step S99, the processing proceeds to step S101.

In step S101, the downmix/upmix processing unit 73 reads the adjustment information being associated with the television receiver 33 serving as a reproduction device and registered in the database by reproduction device 55. The television receiver 33 serving as a reproduction device is determined by the identification information. The downmix/upmix processing unit 73 then determines whether downmixing is necessary.

When downmixing is, for example, determined to be necessary in step S101, the processing proceeds to step S102.

In step S102, for the audio data of the content data, the downmix/upmix processing unit 73 performs downmixing, so as to correspond to the television receiver 33 requesting the reproduction of the content.

Note that when downmixing is, for example, determined to be unnecessary in step S101, the processing in step S102 is skipped.

In step S103, the downmix/upmix processing unit 73 reads the adjustment information being associated with the television receiver 33 serving as a reproduction device and registered in the database by reproduction device 55. The television receiver 33 serving as a reproduction device is determined by the identification information. The downmix/upmix processing unit 73 then determines whether virtualizer is necessary.

When the virtualizer is, for example, determined to be necessary in step S103, the processing proceeds to step S104.

In step S104, for the audio data of the content data, the downmix/upmix processing unit 73 applies the virtualizer, so as to correspond to the television receiver 33 requesting the reproduction of the content. The downmix/upmix processing unit 73 then supplies the audio data of the content data to the transcode processing unit 74.

Note that when the virtualizer is, for example, determined to be unnecessary in step S103, the processing in step S104 is skipped, and the content data is supplied to the transcode processing unit 74.

In step S105, the transcode processing unit 74 reads the adjustment information being associated with the television receiver 33 serving as a reproduction device and registered in the database by reproduction device 55. The television receiver 33 serving as a reproduction device is determined by the identification information. The transcode processing unit 74 then determines whether transcoding according to the television receiver 33 is necessary.

When transcoding is, for example, determined to be necessary in step S105, the processing proceeds to step S106.

In step S106, for the audio data of the content data, the transcode processing unit 74 performs transcoding, so as to correspond to the television receiver 33 requesting the reproduction of the content. The transcode processing unit 74 then supplies the audio data of the content data to the delay processing unit 75.

Note that when transcoding is, for example, determined to be unnecessary in step S105, the processing in step S106 is skipped, and the content data is supplied to the delay processing unit 75.

In step S107, the delay processing unit 75 reassigns a timestamp to the content data, on which various processing has been done, according to a delay time generated by the processing. Note that in a case where the server device 31 distributes content stored in the server device 31 itself, the image and audio can be output at a time. In this case, this processing of reassigning a timestamp is not necessary. The processing performed here is, for example, to adjust timing between an image with no delay time generated and audio with a delay generated due to processing, in a case where content is read from an external server and only the audio data is adjusted by using the adjustment information registered in the database by reproduction device 55, while the image is not adjusted.

In step S108, the control unit 51 controls the command transmission unit 60 to transmit a streaming command to the television receiver 33 via the communication unit 52. In this manner, the command transmission unit 60 transmits the streaming command 92 to the television receiver 33 via the communication unit 52 and the network 32.

When the control unit 121 of the television receiver 33 receives the streaming command 92 by controlling the communication unit 123 in step S73, the control unit 121 recognizes that streaming will start, and at the same time, the control unit 121 controls the audio quality adjustment unit 122 to stop the adjustment of the audio quality.

In step S109, the control unit 51 of the server device 31 causes the audio adjustment unit 58 to output the content data to the communication unit 52, thereby transmitting the content data to the television receiver 33 via the network 32.

In step S74, the control unit 121 of the television receiver 33 controls the communication unit 123 to receive the content data, while controlling the decode processing unit 126 to decode the content data. The control unit 121 then causes the display unit 125 to display an image based on the decoded content data, while causing the speaker 124 to output the audio, whereby the content is reproduced.

Note that although the example described hereinabove has been a case where a reproduction device is the television receiver 33, another device may be possible as long as the device is a reproduction device including an audio output, such as an audio system. Furthermore, in a case where a highly functional mobile terminal is used as a reproduction device, for example, similar operations can also be realized in a similar method.

With the processing above, it is possible to realize the distribution of the content including suitable audio data in which necessary frequency characteristic and phase characteristic, transcoding, a sampling frequency, the number of channels, and virtualizer have been taken into account according to the reproduction device that outputs the audio of the content.

As a result, it is possible to realize the reproduction of the content including the audio being suitable for the performance of the reproduction device, such as the television receiver 33, without changing the configuration of the reproduction device.

In addition, although the example described hereinabove has been as to the generation and distribution of the audio data optimized for the audio function of the reproduction device, the image display function may also be optimized by applying the above-described method. More specifically, by causing the measurement image data to be displayed on the television receiver 33 and then captured by the mobile terminal 34, the server device 31 may adjust, on the basis of the captured result, the content data, so as to be displayed as an optimal image when the content is displayed on the television receiver 33. Then, the server device 31 may supply the content data to the television receiver 33, causing the television receiver 33 to display the content data. By performing such processing on both of the audio data and the image data, the audio data and image data can be reproduced in optimal states on the reproduction device.

Furthermore, the example described hereinabove has been a case where the function of the audio quality adjustment unit 122 is stopped in both cases when the adjustment information is registered (the audio quality/function measurement processing is executed) and when the content is reproduced (the content output processing is executed). However, in either case, the function of the audio quality adjustment unit 122 may not be subjected to being stopped. Furthermore, the adjustment information for the case where the function of the audio quality adjustment unit 122 is stopped and the adjustment information for the case where the function of the audio quality adjustment unit 122 is not stopped may be each registered in the database by reproduction device 55, either one of which may be used according to the corresponding condition.

<First Modification>

The example described hereinabove has been a case where the audio data of the content that the reproduction device requests for distribution is distributed in an optimized state for the audio output function of the reproduction device by the server device (cloud server device) 31. However, the television receiver 33 serving as a reproduction device may also receive content via a broadcast wave and supply the received content to the server device 31. After the content is converted into optimal audio data on the basis of adjustment information, the content may be retransmitted to and reproduced on the television receiver 33.

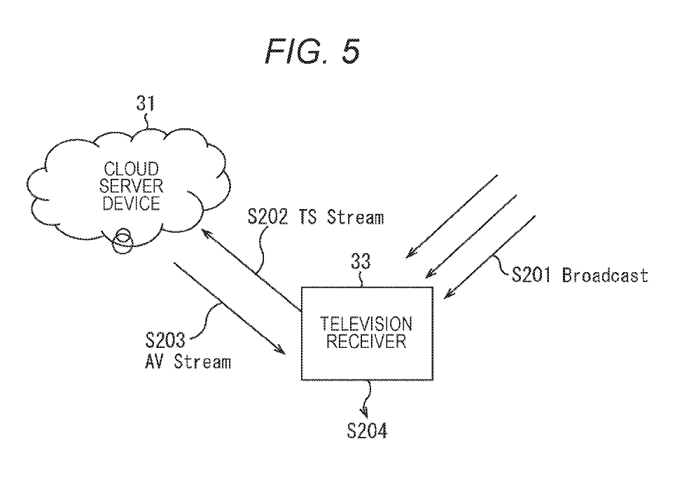

More specifically, as illustrated in FIG. 5, the television receiver 33 receives the content distributed via a broadcast wave (Broadcast in the figure) in step S201.

In step S202, the television receiver 33 transmits the content distributed via the broadcast wave (Broadcast in the figure) as a Transport (TS) Stream to the cloud server device (server device in FIG. 2) 31.

In step S203, the server device 31 transmits, to the television receiver 33, an AV Stream including the content with the audio data, on which optimization has been done by using the above-mentioned adjustment information registered in the database by reproduction device 55.

In step S204, the television receiver 33 reproduces the content including the optimized audio data.

With the processing as above, the content distributed via the broadcast wave and received by the television receiver 33 can also be reproduced as audio data optimized for the performance of the audio output function of the television receiver 33 by the cloud server device 31.

<Second Modification>

The example described hereinabove has been a case where the server device (cloud server device) 31 stores adjustment information for a reproduction device in the database by reproduction device 55 and optimizes the audio data by using the adjustment information.

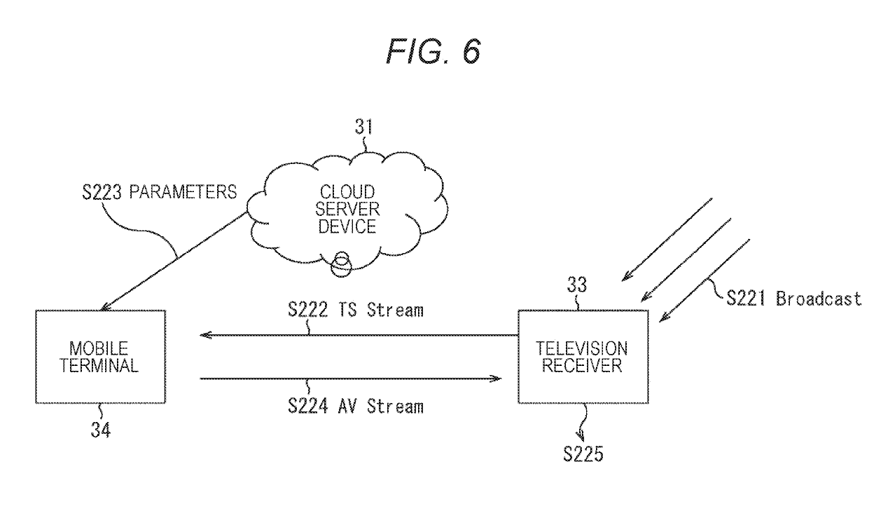

However, the function for storing adjustment information for a reproduction device in the database by reproduction device 55 and the function for optimizing audio data by using the adjustment information may be realized in separate device configurations. For example, as illustrated in FIG. 6, the distribution system may include a cloud server device 31 and a mobile terminal 34. The cloud server device 31 may include the function for storing adjustment information for a reproduction device in the database by reproduction device 55. The mobile terminal 34 may include the function for optimizing audio data by using a parameter including the adjustment information.

More specifically, as illustrated in FIG. 6, the television receiver 33 receives content distributed via a broadcast wave (Broadcast in the figure) in step S221.

In step S222, the television receiver 33 transmits a TS Stream of the content distributed by the broadcast wave (Broadcast in the figure) to the mobile terminal 34. The mobile terminal 34 includes the function for optimizing audio data by using adjustment information.

In step S223, the server device (cloud server device) 31 transmits a parameter including the adjustment information to the mobile terminal 34. The server device (cloud server device) 31 includes the function for storing adjustment information for a reproduction device (television receiver 33) in the database by reproduction device 55.

In step S224, the mobile terminal 34 realizes the optimization of the audio data of the content by using the parameter including the adjustment information supplied by the server device (cloud server device) 31. The mobile terminal 34 then transmits an AV Stream of the optimized content to the television receiver 33.

In step S225, the television receiver 33 reproduces the content including the optimized audio data.

With the processing as above, the mobile terminal 34 can convert the content distributed via the broadcast wave and received by the television receiver 33 into optimal audio data for the performance of the audio output function of the television receiver 33 by using a parameter including the adjustment information supplied from the cloud server device 31, and supply the content to the television receiver 33. This allows the television receiver 33 to reproduce the content including the optimal audio data.

<Third Modification>

The examples described hereinabove have been a case where the server device (cloud server device) 31 stores the adjustment information for a reproduction device in the database by reproduction device 55, and the audio data of the content distributed to the television receiver 33 via a broadcast wave is optimized using the adjustment information.

However, the content data to be reproduced may also be other than the content distributed via the broadcast wave. For example, the function for storing adjustment information for a reproduction device in the database by reproduction device 55 and the function for optimizing audio data by using a parameter including the adjustment information may be realized in separate device configurations. The audio data of the content stored in the server may be supplied to and reproduced on the television receiver 33 after being optimized by the mobile terminal 34.

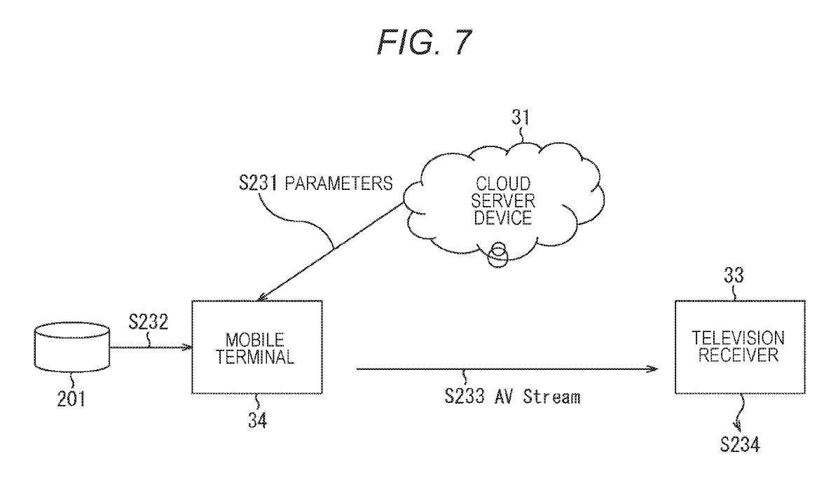

More specifically, for example, as illustrated in FIG. 7, the distribution system may include a cloud server device 31 and a mobile terminal 34, in which the mobile terminal 34 may read content data from a content server 201. The cloud server device 31 may include a function for storing adjustment information for a reproduction device in the database by reproduction device 55. The mobile terminal 34 may include a function for optimizing audio data by using a parameter including the adjustment information.

More specifically, as illustrated in FIG. 7, the server device (cloud server device) 31 transmits a parameter including the adjustment information to the mobile terminal 34 in step S231. The server device (cloud server device) 31 includes the function for storing adjustment information for a reproduction device (television receiver 33) in the database by reproduction device 55.

In step S232, the mobile terminal 34 reads content from the content server 201. The mobile terminal 34 includes the function for optimizing audio data by using a parameter including the adjustment information.

In step S233, the mobile terminal 34 optimizes the audio data of the content data read from the content server 201 by using the parameter including the adjustment information supplied by the server device (cloud server device) 31. The mobile terminal 34 then transmits, to the television receiver 33, an AV Stream of the content in which the audio data has been optimized.

In step S234, the television receiver 33 reproduces the content including the optimized audio data.

With the processing as above, the mobile terminal 34 can convert the content stored in the content server 201 into optimal audio data for the performance of the audio output function of the television receiver 33 by using a parameter including adjustment information supplied from the cloud server device 31, and then supply the content to the television receiver 33. This allows the television receiver 33 to reproduce the content including the optimal audio data.

As described above, in any cases, it is possible to reproduce the content with the optimized audio data, without adding any special device or the like to a reproduction device.

Additionally, the series of the processing described above can be executed by hardware, but can also be executed by software. In a case where the series of processing is executed by software, a program constituting the software is installed, via a storage medium, in a computer incorporated in dedicated hardware, or in a computer, for example, a general-purpose personal computer or the like, capable of executing various functions when various programs are installed.

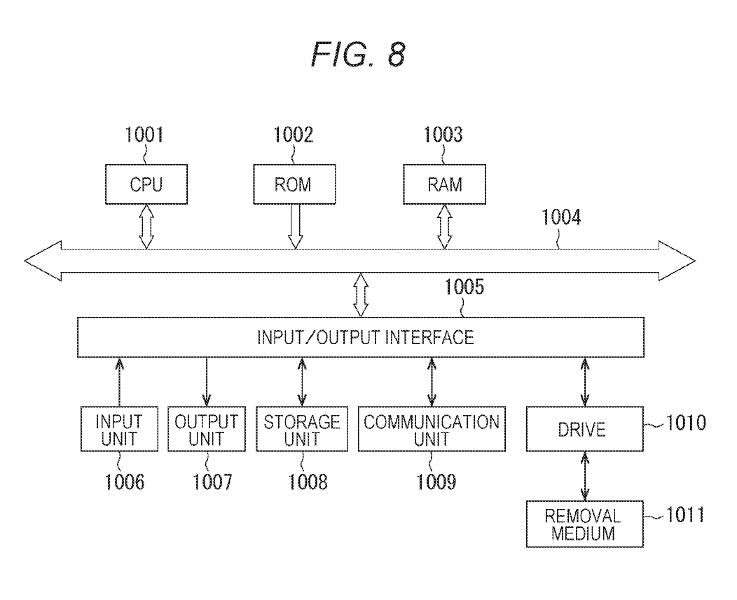

FIG. 8 illustrates an exemplary configuration of the general-purpose personal computer. This personal computer includes a central processing unit (CPU) 1001. An input/output interface 1005 is connected to the CPU 1001 via a bus 1004. A read only memory (ROM) 1002 and a random access memory (RAM) 1003 are connected to the bus 1004.

An input unit 1006, an output unit 1007, a storage unit 1008, and a communication unit 1009 are connected to the input/output interface 1005. The input unit 1006 includes an input device such as a keyboard and a mouse, with which a user inputs an operation command. The output unit 1007 outputs a processing operation screen and an image of a processing result to a display device. The storage unit 1008 includes a hard disk drive and the like, and stores a program and various data. The communication unit 1009 includes a local area network (LAN) adapter and the like, and executes communication processing via a network represented by the Internet. In addition, a drive 1010 that reads and writes data to a removable medium 1011 is connected. The removable medium 1011 is a magnetic disk (including a flexible disk), an optical disk (including a compact disc-read only memory (CD-ROM) and a digital versatile disc (DVD)), a magneto-optical disk (including a mini disc (MD)), a semiconductor memory, or the like.

The CPU 1001 executes various processing according to a program stored in the ROM 1002 or a program loaded into the RAM 1003 from the storage unit 1008 after being read from the removable medium 1011, and then installed in the storage unit 1008. The removable medium 1011 is a magnetic disk, an optical disk, a magneto-optical disk, a semiconductor memory, or the like. When needed, the RAM 1003 also stores data or like, which is necessary for the CPU 1001 to execute various processing.

In the computer configured as above, the CPU 1001, for example, loads a program stored in the storage unit 1008 into the RAM 1003 through the input/output interface 1005 and the bus 1004, and executes the program, whereby the series of processing described above is performed.

The program to be executed by the computer (CPU 1001) may be provided by being recorded in the removable medium 1011 serving as a package medium or the like, for example. Alternatively, the program can be provided through a wired or wireless transmission medium such as a local area network, the Internet, or digital satellite broadcasting.

In the computer, the program can be installed in the storage unit 1008 through the input/output interface 1005 by attaching the removable medium 1011 to the drive 1010. Alternatively, the program can be received by the communication unit 1009 through a wire or wireless transmission medium and installed in the storage unit 1008. For other cases, the program can be installed in the ROM 1002 or the storage unit 1008 in advance.

Note that the program executed by the computer may be a program that executes processing in a chronological order according to the order described in this specification, or may be a program that executes processing in parallel or at necessary timing when a call is made, for example.

Furthermore, in this specification, the system represents a collection of a plurality of components (e.g., devices and modules (parts)), and it does not matter whether all the components are within the same housing. Therefore, a plurality of devices housed in separate housings and connected via a network, and a single device in which a plurality of modules is housed within a single housing is, in either case, the system.

Note that the embodiments of the present technology are not limited to the above-described embodiments, and various modifications can be made without departing from the gist of the present technology.

For example, the present technology can take a configuration of cloud computing in which one function is shared by a plurality of devices through a network and processed in cooperation.

Furthermore, each of the steps described in the above-described flowcharts can be executed by a single device, but can also be shared and executed by a plurality of devices.

In addition, in a case where a plurality of processing is included in a single step, the plurality of processing included in the single step can be executed by a single device, but can also be shared and performed by a plurality of devices.

Additionally, the present technology may also be configured as below.

(1) A server device to distribute content to a reproduction device, the server device including:

an adjustment unit configured to adjust content data of the content to correspond to a reproduction function of the reproduction device.

(2) The server device according to (1), further including:

an analysis unit configured to analyze audio output from the reproduction device; and

an adjustment information storage unit configured to store, in association with information identifying the reproduction device, adjustment information necessary for adjusting the content data to correspond to the reproduction function of each reproduction device based on an analysis result of the analysis unit,

wherein the adjustment unit adjusts the content data on the basis of the adjustment information.

(3) The server device according to (2),

wherein the analysis unit analyzes a frequency characteristic and a phase characteristic of the audio output from the reproduction device,

the adjustment information storage unit stores the adjustment information necessary for adjusting the content data to correspond to the frequency characteristic and the phase characteristic of the reproduction function of the reproduction device on the basis of the analysis result of the analysis unit, and

the adjustment unit adjusts the content data to correspond to the frequency characteristic and the phase characteristic of the reproduction function of the reproduction device on the basis of the adjustment information.

(4) The server device according to (2) or (3),

wherein the analysis unit analyzes availability of virtualizer of the reproduction device on the basis of the audio output from the reproduction device,

the adjustment information storage unit stores, as the adjustment information, information indicating necessity of adjusting the content data with the virtualizer, when the virtualizer is not included in the reproduction function of the reproduction device, on the basis of the analysis result of the analysis unit, and

the adjustment unit adjusts the content data by performing virtualizer processing to correspond to the reproduction function of the reproduction device on the basis of the adjustment information.

(5) The server device according to any one of (2) to (4),

wherein the analysis unit analyzes a coding format of the reproduction device on the basis of the audio output from the reproduction device,

the adjustment information storage unit stores, as the adjustment information, information indicating the coding format corresponding to the reproduction function of the reproduction device based on the analysis result of the analysis unit, and

the adjustment unit processes and adjusts the content data such that the coding format corresponds to the reproduction function of the reproduction device on the basis of the adjustment information.

(6) The server device according to (2) to (5),

wherein the analysis unit analyzes the number of channels of the reproduction device on the basis of the audio output from the reproduction device,

the adjustment information storage unit stores, as the adjustment information, information indicating the number of channels corresponding to the reproduction function of the reproduction device based on the analysis result of the analysis unit, and

the adjustment unit processes and adjusts the content data such that the number of channels corresponds to the reproduction function of the reproduction device based on the adjustment information.

(7) The server device according to any one of (2) to (6),

wherein the analysis unit analyzes a sampling frequency of the reproduction device on the basis of the audio output from the reproduction device,

the adjustment information storage unit stores, as the adjustment information, information indicating the sampling frequency corresponding to the reproduction function of the reproduction device on the basis of the analysis result of the analysis unit, and

the adjustment unit adjusts the content data by converting a sampling rate such that the number of samples corresponds to the reproduction function of the reproduction device based on the adjustment information.

(8) The server device according to any one of (2) to (7),

wherein the reproduction device includes an audio quality adjustment unit configured to adjust audio quality of the content to be reproduced,

the server device further includes a command output unit configured to output a command for stopping an operation of the audio quality adjustment unit,

the analysis unit analyzes both of audios output from the reproduction device during the audio quality adjustment unit being in an operating state and being in an inoperative state by the command output unit,

the adjustment information storage unit stores, for each of the operating state and the inoperative state of the audio quality adjustment unit, the adjustment information being associated with the information identifying the reproduction device and necessary for adjusting the content data to correspond to the reproduction function of each reproduction device based on the analysis result of the analysis unit, and

the adjustment unit makes an adjustment to correspond to the reproduction function of the reproduction device based on the adjustment information for each of the operating state and the inoperative state of the audio quality adjustment unit.

(9) The server device according to any one of (1) to (8),

wherein the content includes content to be distributed through a broadcast wave, and

the server device further includes a delay processing unit configured to reassign, in a case where the content is distributed via the broadcast wave, a timestamp according to a delay generated when the content data is adjusted by the adjustment unit.

(10) The server device according to any one of (1) to (9),

wherein the server device configures a distribution system together with a mobile terminal and the reproduction device, the mobile terminal configured to collect audio output from the reproduction device, and

the analysis unit analyzes the audio output from the reproduction device and collected by the mobile terminal.

(11) The server device according to any one of (1) to (10), further including:

a cloud server device including a plurality of server devices connected via a network.

(12) An information processing method for a server device that distributes content to a reproduction device, the information processing method comprising the step of:

adjusting content data of the content to correspond to a reproduction function of the reproduction device.

(13) A program to be executed to cause a computer, configured to control a server device that distributes content to a reproduction device, to function as:

an adjustment unit configured to adjust content data of the content to correspond to a reproduction function of the reproduction device.

### REFERENCE SIGNS LIST

31 Server device (cloud server device)
32 Network
33 Television receiver
34 Mobile terminal
51 Control unit
52 Communication unit
53 Audio data acquisition unit
54 Supporting function determination unit
55 Database by reproduction device
56 Performance measurement unit
57 Correction parameter calculation unit
58 Audio quality adjustment unit
59 Content storage unit
60 Command transmission unit
61 Measurement audio source data storage processing unit
71 Frequency/phase characteristics correction unit
72 Rate conversion unit
73 Downmix/upmix processing unit
74 Transcode processing unit
75 Delay processing unit
91 Audio quality/function measurement command
92 Streaming command
101 Control unit
102 Microphone
103 Communication unit
104 Operation input unit
105 Display unit
106 Speaker
121 Control unit
122 Audio quality adjustment unit
123 Communication unit
124 Speaker
125 Display unit
126 Decode processing unit
127 Operation input unit

1. A server device to distribute content to a reproduction device, the server device comprising:
an adjustment unit configured to adjust content data of the content to correspond to a reproduction function of the reproduction device.

2. The server device according to claim 1, further comprising:
an analysis unit configured to analyze audio output from the reproduction device; and
an adjustment information storage unit configured to store, in association with information identifying the reproduction device, adjustment information necessary for adjusting the content data to correspond to the reproduction function of each reproduction device based on an analysis result of the analysis unit,
wherein the adjustment unit adjusts the content data on the basis of the adjustment information.

3. The server device according to claim 2,
wherein the analysis unit analyzes a frequency characteristic and a phase characteristic of the audio output from the reproduction device,
the adjustment information storage unit stores the adjustment information necessary for adjusting the content data to correspond to the frequency characteristic and the phase characteristic of the reproduction function of the reproduction device on the basis of the analysis result of the analysis unit, and
the adjustment unit adjusts the content data to correspond to the frequency characteristic and the phase characteristic of the reproduction function of the reproduction device on the basis of the adjustment information.

4. The server device according to claim 2,
wherein the analysis unit analyzes availability of virtualizer of the reproduction device on the basis of the audio output from the reproduction device,
the adjustment information storage unit stores, as the adjustment information, information indicating necessity of adjusting the content data with the virtualizer, when the virtualizer is not included in the reproduction function of the reproduction device, on the basis of the analysis result of the analysis unit, and
the adjustment unit adjusts the content data by performing virtualizer processing to correspond to the reproduction function of the reproduction device on the basis of the adjustment information.

5. The server device according to claim 2,
wherein the analysis unit analyzes a coding format of the reproduction device on the basis of the audio output from the reproduction device,
the adjustment information storage unit stores, as the adjustment information, information indicating the coding format corresponding to the reproduction function of the reproduction device based on the analysis result of the analysis unit, and
the adjustment unit processes and adjusts the content data such that the coding format corresponds to the reproduction function of the reproduction device on the basis of the adjustment information.

6. The server device according to claim 2,
wherein the analysis unit analyzes the number of channels of the reproduction device on the basis of the audio output from the reproduction device,
the adjustment information storage unit stores, as the adjustment information, information indicating the number of channels corresponding to the reproduction function of the reproduction device based on the analysis result of the analysis unit, and
the adjustment unit processes and adjusts the content data such that the number of channels corresponds to the reproduction function of the reproduction device based on the adjustment information.

7. The server device according to claim 2,
wherein the analysis unit analyzes a sampling frequency of the reproduction device on the basis of the audio output from the reproduction device,
the adjustment information storage unit stores, as the adjustment information, information indicating the sampling frequency corresponding to the reproduction function of the reproduction device on the basis of the analysis result of the analysis unit, and
the adjustment unit adjusts the content data by converting a sampling rate such that the number of samples corresponds to the reproduction function of the reproduction device based on the adjustment information.

8. The server device according to claim 2,
wherein the reproduction device includes an audio quality adjustment unit configured to adjust audio quality of the content to be reproduced,
the server device further includes a command output unit configured to output a command for stopping an operation of the audio quality adjustment unit,
the analysis unit analyzes both of audios output from the reproduction device during the audio quality adjustment unit being in an operating state and being in an inoperative state by the command output unit,
the adjustment information storage unit stores, for each of the operating state and the inoperative state of the audio quality adjustment unit, the adjustment information being associated with the information identifying the reproduction device and necessary for adjusting the content data to correspond to the reproduction function of each reproduction device based on the analysis result of the analysis unit, and
the adjustment unit makes an adjustment to correspond to the reproduction function of the reproduction device based on the adjustment information for each of the operating state and the inoperative state of the audio quality adjustment unit.

9. The server device according to claim 1,
wherein the content includes content to be distributed through a broadcast wave, and
the server device further includes a delay processing unit configured to reassign, in a case where the content is distributed via the broadcast wave, a timestamp according to a delay generated when the content data is adjusted by the adjustment unit.

10. The server device according to claim 1,
wherein the server device configures a distribution system together with a mobile terminal and the reproduction device, the mobile terminal configured to collect audio output from the reproduction device, and
an analysis unit analyzes the audio output from the reproduction device and collected by the mobile terminal.

11. The server device according to claim 1, further comprising:
a cloud server device including a plurality of server devices connected via a network.

12. An information processing method for a server device that distributes content to a reproduction device, the information processing method comprising the step of:
adjusting content data of the content to correspond to a reproduction function of the reproduction device.

13. A program to be executed to cause a computer, configured to control a server device that distributes content to a reproduction device, to function as:
an adjustment unit configured to adjust content data of the content to correspond to a reproduction function of the reproduction device.
